(19) United States
(12) Patent Application Publication
(10) Pub. No.: US 2020/0207177 A1
(43) Pub. Date: Jul. 2, 2020

(54) STRUT-PRESSED BAR

(71) Applicant: Chanapong PHANCHAROEN, Bangkok (TH)

(72) Inventor: Chanapong PHANCHAROEN, Bangkok (TH)

(21) Appl. No.: 16/640,494

(22) PCT Filed: Jul. 31, 2018
(86) PCT No.: PCT/TH2018/000033

§ 371 Date: Feb. 20, 2020

(30) Foreign Application Priority Data
Sep. 6, 2017 (TH) 1703001717

(51) Int. Cl. B60G 21/055

(52) U.S. Cl. CPC B60G 21/0551; B60G 2200/34; B60G 2206/8201; B60G 2206/7102; B60G 2204/10

(57) ABSTRACT

Strut-Pressed Bar to be installed to the suspension of the car composed of two Moaatmg-Flates cut into round shape with the circular shape hole at the center that is big enough to allow the exposure of the tip of the shock-sbsorber shaft. At the rim, the holes will be drilled at the point that is match to the position of the existing bolt on the top caps of the strut-assembly to be fixed to each other. On top of the Mounting-Plate was welded with the U-shape steel plate with 2 holes drilled at the base of the II and both 2 wings extend through the rim of the mounting plate to round the tip of the shock, absorber-shaft in the middle. The strut-bar made of flat aluminium bar bended into the bird-wing shape or stretch letter M, at both ends were vertically welded with the aluminium plate with 2 holes drilled to be mounted tp the die U-shape on the Mounting-Plates

### TECHNICAL FIELD

Mechanical automotive engineering concerning reinforcement of front and rear suspension of the vehicle

### BACKGROUND ART

The general passenger car must have a 4 wheel configurations of which the suspension system of each wheel of the car must be installed. The suspension system was designed to support the load of the car transfer to the wheels which attached to the road surface.

The front suspension of the car composed of the strut assembly which has the coil-spring placed on top of the shock-absorber cartridge which be mounted with the wheel at the lower end.

The wheel and the strut-assembly will absorb the impact force from the road surface to the strut tower of the body of the car, as when a pot-hole or bump on the road surface is encountered that generated the impact force which will cause the car body of which part attached to the strut tower to be fatigued (cracked) or bend.

When the vehicle turn left or right, the car body on the inside of the curve will be risen up due to the centrifugal force, that cause reduction to the pressure and contact of the wheel to the road surface thus causing understeering or oversteering leaded to slippery and crashed.

Due to these mentioned problem, there be an invention to alleviate the stress of press on the top of the strut-tower believing that will increase stability of the strut-tower that will prevent bending of the car body attached to the strut-tower and increase more firmly attachment of the wheel to the road surface.

For the contemporary original design, the strut-bar composed of the Mounting Plate (1) made of steel plate cut into round shape to match with the top part of the strut tower. The center part of the Mounting Plate (1) was cut to be circle shape, big enough to let the tip of the shock absorber shaft to expose at the center. At the rim of the Mounting Plate (1), the holes (5) will be drilled at the point that can be inserted by the bolt which was fixed to the cap of the shock-absorber shaft and mounted together by nuts. The Strut-Bar (2) made of metal such as stainless steel, carbon steel or aluminum in flat or round tube shape to be fixed with the tab (4) welded at the inner rim of the Mounting Plate (1).

According to this design, the force will transfer directly to both opposite side via the strut bar in the horizontal direction that does not help to press on the top of the strut tower which will not transfer the pressure to the wheel to keep the wheels firmly contact to the road surface, on the curving road swaying left and right this does not alleviate the problem of loss of wheel contact to the road surface.

### PURPOSE OR OBJECTIVE OF THIS INVENTION

This new design for the Strut-Pressed bar is to be mounted on top of the strut-tower to resist twisting of the part of the body attached to the strut tower and create a resist pressure to the wheel when it was impacted upward or downward due to the pot-hole or the bump or wavy surface of the road and or when the car ran into a curvy road, the resist pressure will press the wheel to attach firmly to the road surface.

### BRIEF DESCRIPTION OF DRAWINGS

FIG. 1 Showing the Unibody with Strut Towers and Strut Assembly

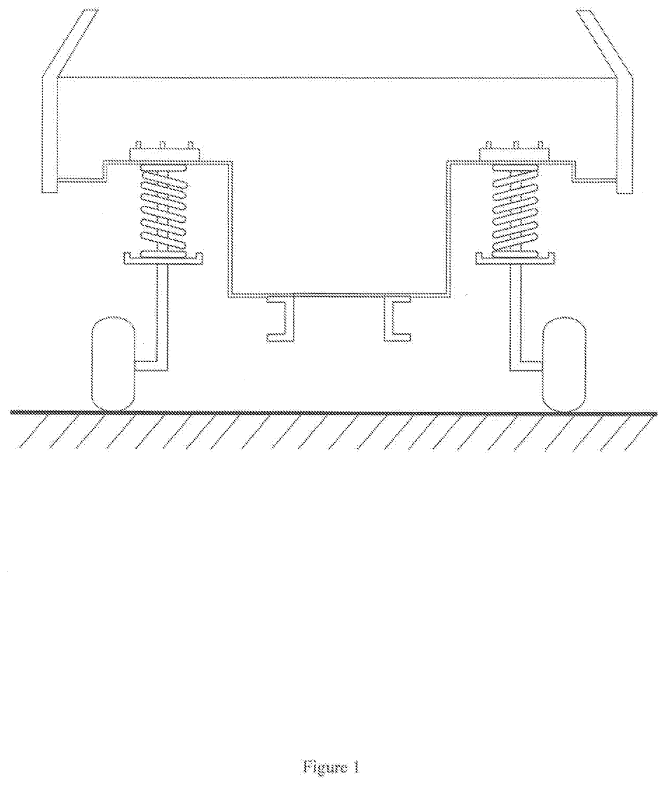

FIG. 2 Showing the Stress and Twisting of the Unibody When the Wheel Impacts With a Pot Hole or a Raised Dump on the Road Surface

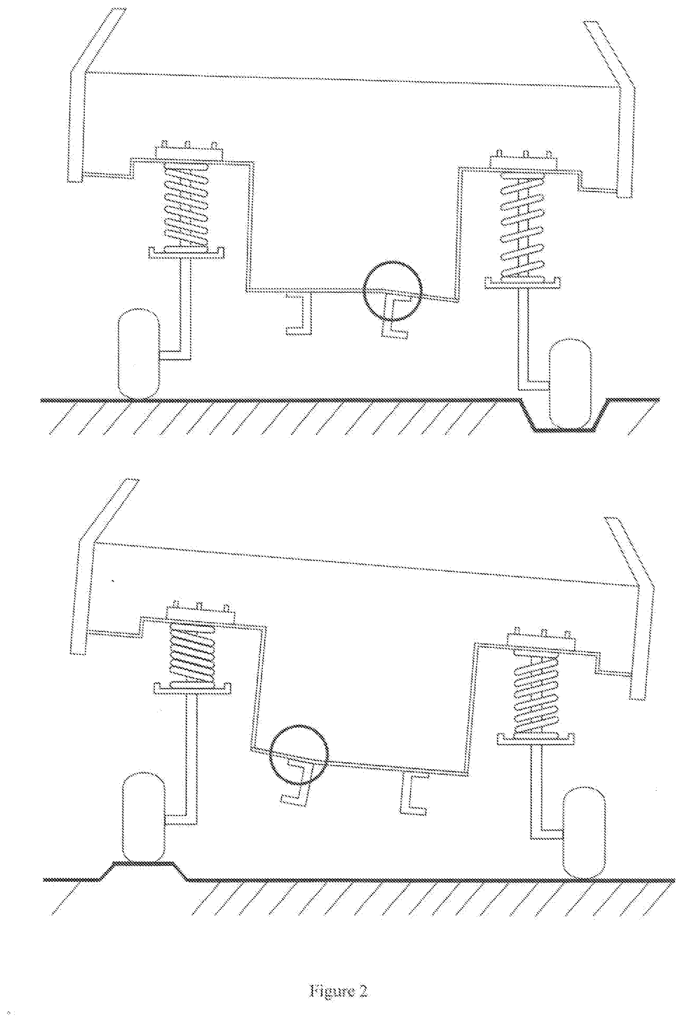

FIG. 3 Showing the Raising and Lowering of the Unibody Under Stress from Turning

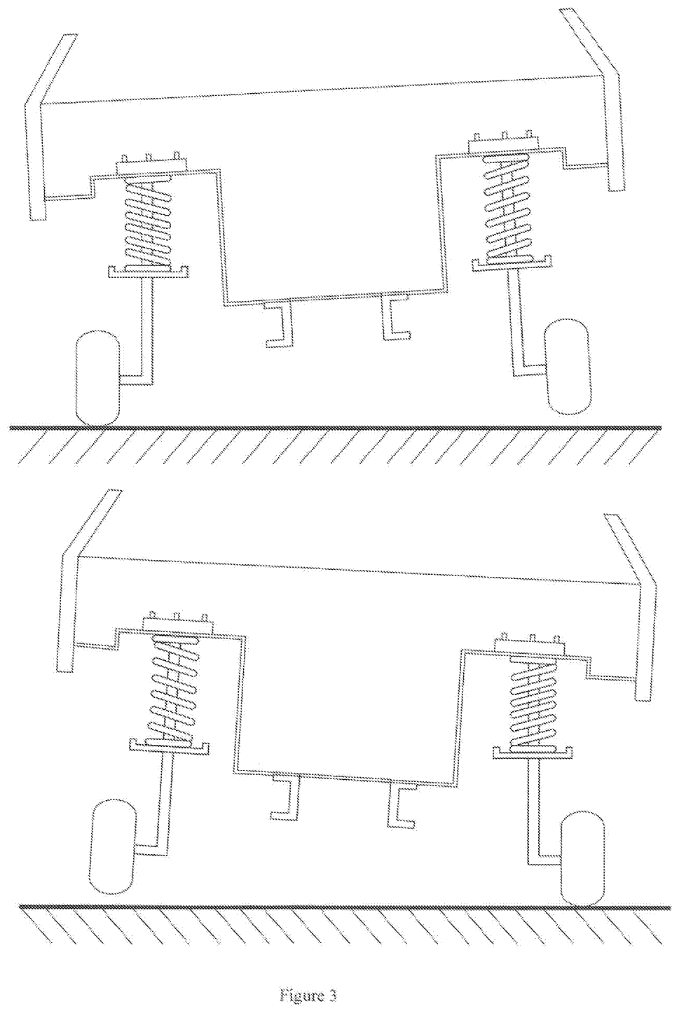

FIG. 4 Showing the Original Design of the Strut Bar Configuration

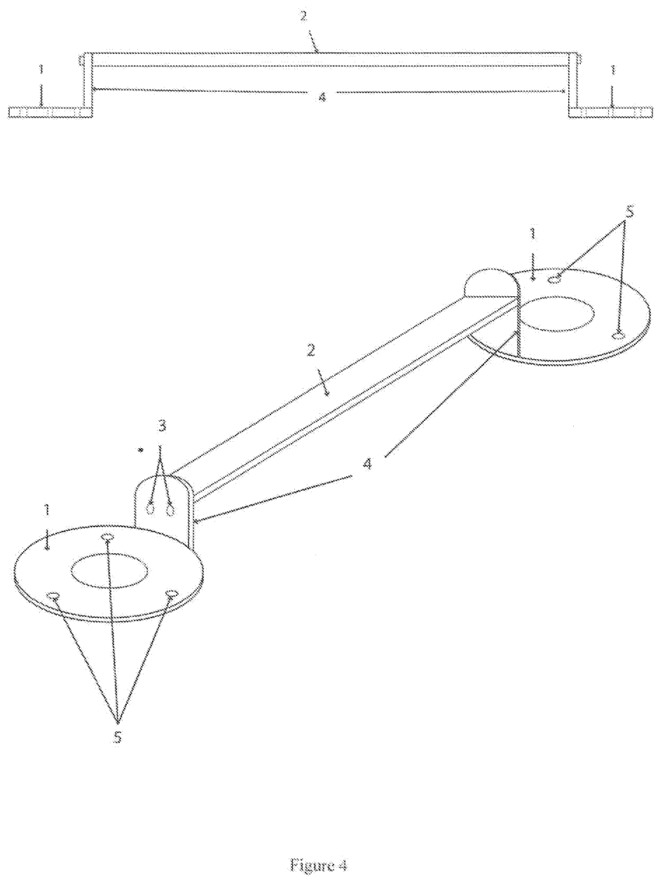

FIG. 5 Showing the Direction of Force Transfer one the Original Strut Bar Design According to the Direction of The Strut Tower

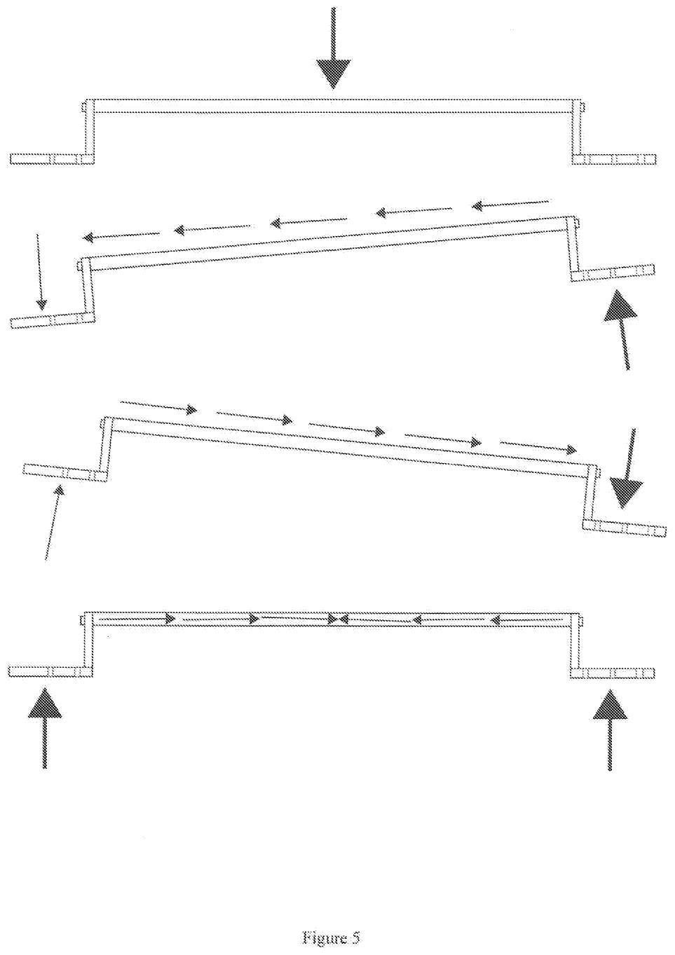

FIG. 6 Showing the Proposed Design of the New and Improved Strut Pressed Bar

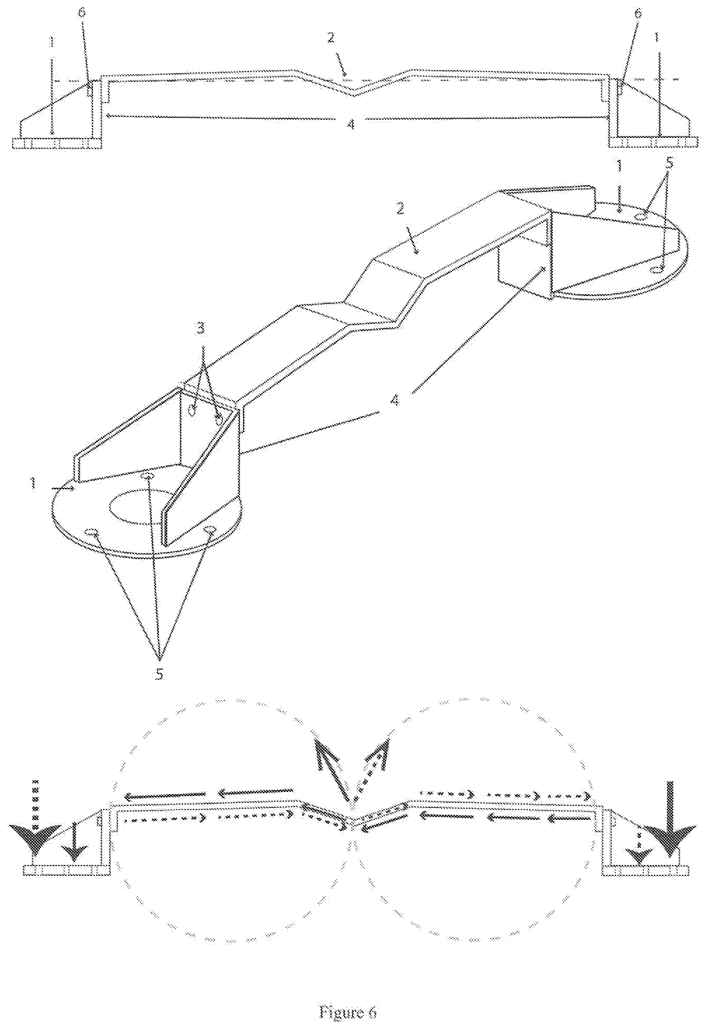

FIG. 7 Showing the Horizontal Direction of the Transfer of Force According to the Change of the Strut Tower

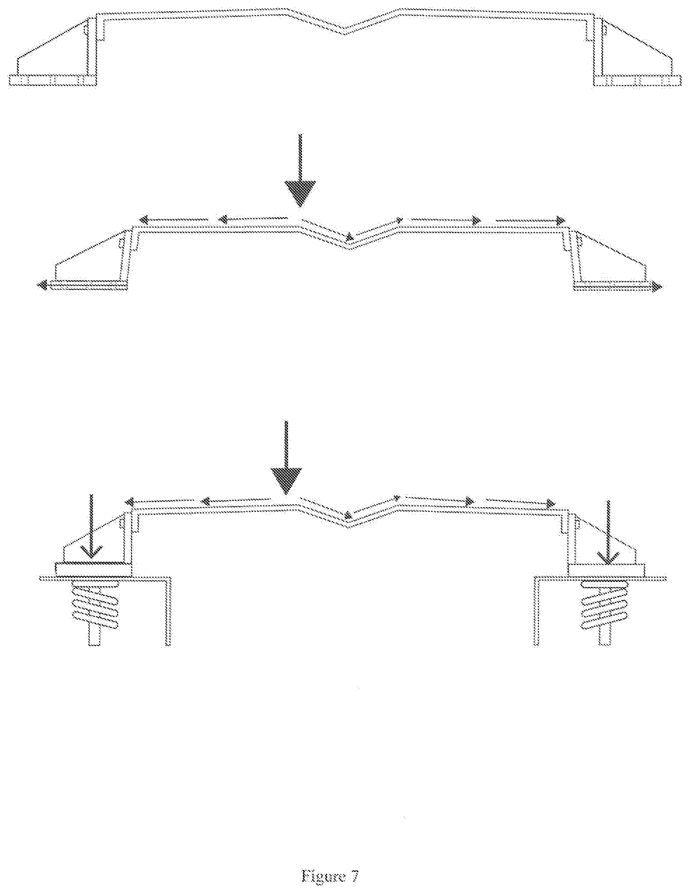

FIG. 8 Showing the Vertical Direction of Force to the Strut Tower Keeping the Pressure on the Strut Tower

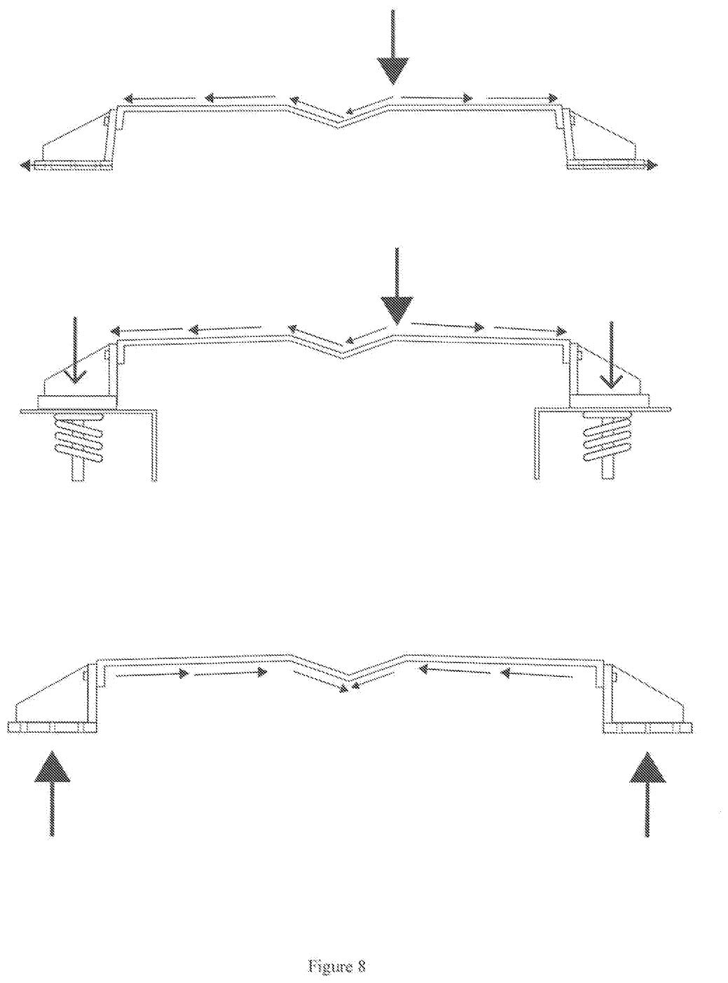

FIG. 9 Showing the Transfer of Force Direction of the Original Strut Bar System When the Vehicle Encounters a Pot Hole or Raised Bump Road Surface

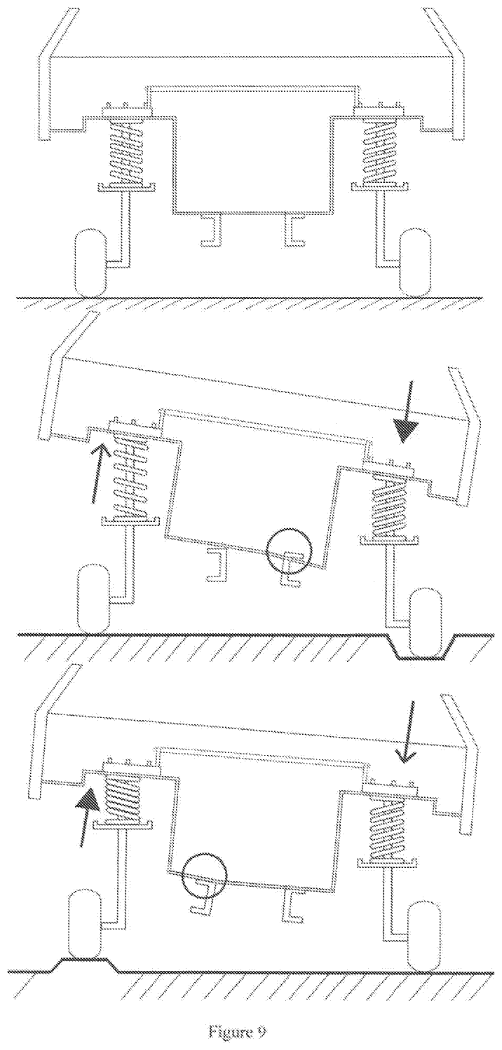

FIG. 10 Showing the Direction of Force Transfer When the Vehicle Turns Left or Right

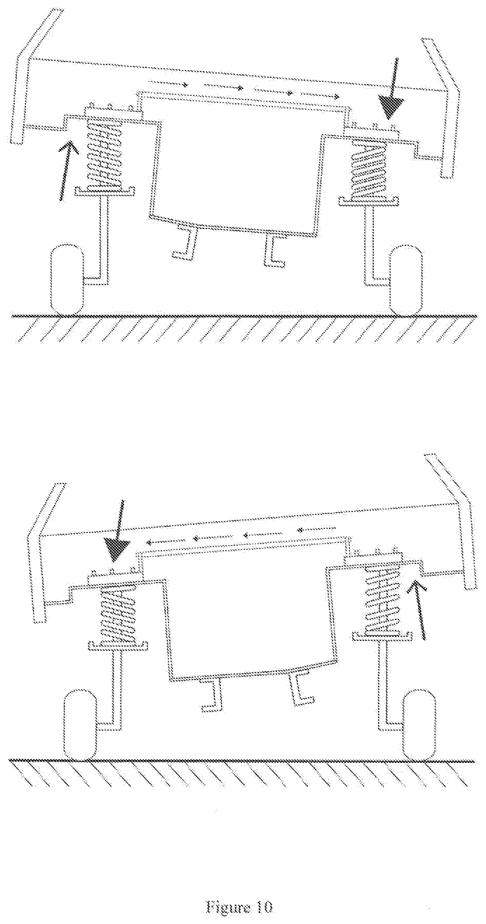

FIG. 11 Showing the Direction of the Force Transfer of the New and Improved Strut Pressed Bar Design When the Vehicle Encounters a Pot Hole or Raised Bump Road Surface

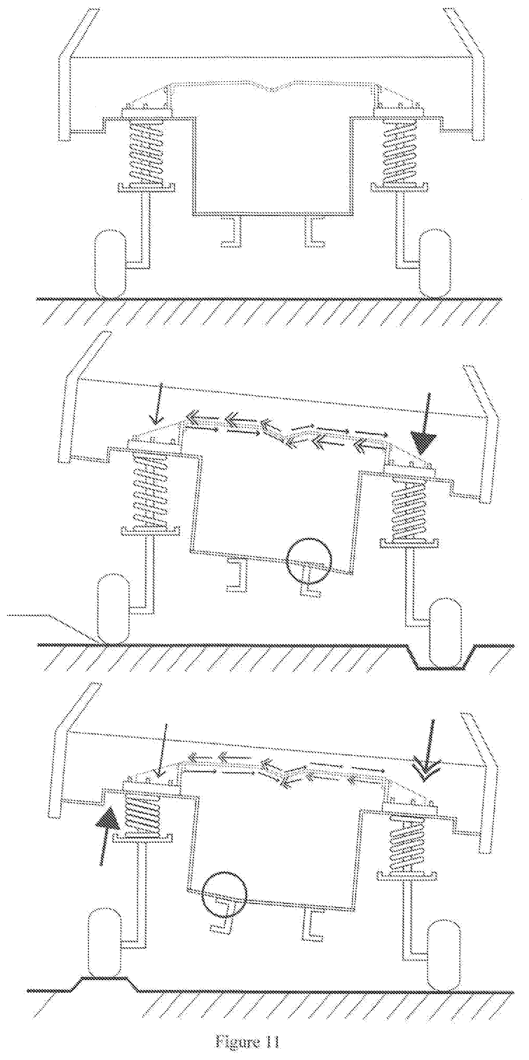

FIG. 12 Showing the Direction of Force When the Vehicle Turns Left or Right

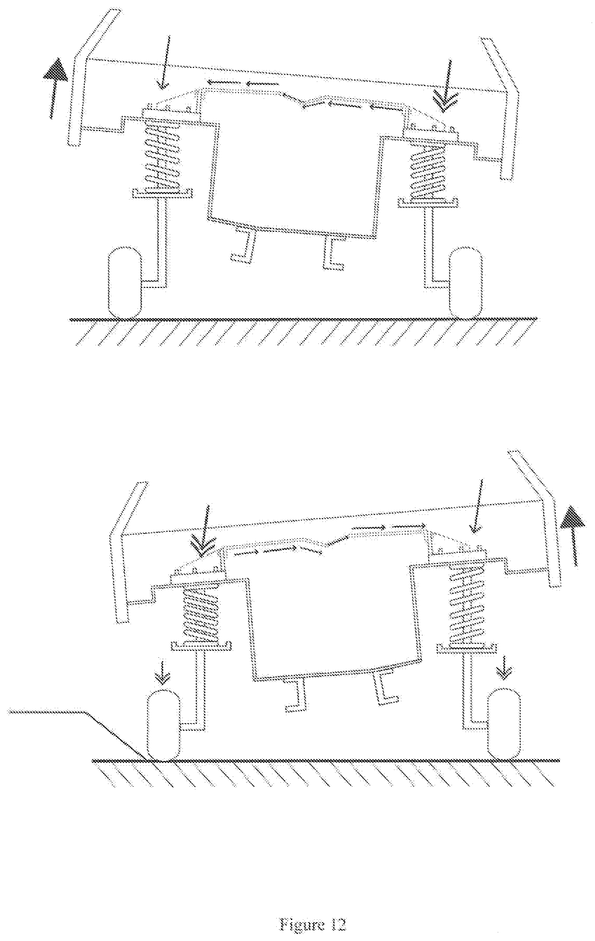

### DISCLOSURE OF THIS INVENTION

The strut tower to be installed to the top cap of the strut-tower of the vehicle by this invention is composed of the Mounting Plates (1) made of steel plate cut into round shape to match with the top part of the strut tower, at the center was cut to be circle shape big enough to allow the tip of the shock absorber shaft to expose at the center of the hole. And the rim of the Mounting Plate (1) was drilled to be Mounting Hole (5) with the position that match to be mounted with the existing Strut Bolt Mounts. On top of the Mounting-Plate (1) was welded with the U-shape tab (4) (Wing Style) made of U-shape steel plate welded at the inner rim of the Mounting Plate (1) with the wings of the U-shape extend to the opposite side to round the tip of the strut-shaft in the middle of the wings, and these wings will be the reinforce resisting-pressure point on to the cap of the strut-tower. At the base of the U-shape tabs (4), there are 2 holes (3) drilled to be mounted with the Strut-Pressed bar by bolts (6).

The Strut-Pressed Bar (2) is made of metal such as aluminum bended into the shape of bird-wing or the stretched letter M. At both ends was in right angle welded with the aluminum plate with 2 holes (3) drilled to be mounted to the 2 holes (3) at the base of the U-shape tabs (4) by bolts (6) on the Mounting-Plate (1).

### BEST MODE FOR CARRYING OUT THE INVENTION

As mentioned above in the paragraphs of the Disclosure of the invention

### INDUSTRIAL APPLICABILITY

To be installed on the suspension system of a vehicle

1. The Strut-Pressed Bar that the design composed of the Mounting-Plate (1) and the Strut-Pressed Bar (2) of which the special feature of this claimed design is the Strut-Pressed Bar (2) made of Aluminium flat bar with thickness of ⅜ inch and 2 or 2½ inches wide bended into the shape of a Bird Wing or the Stretched letter M.
The length of Strut-Pressed Bar (2) will depend on the distance between both side of the strut-tower of the vehicle. At both ends of the aluminum bar was vertically welded with aluminum plate with 2 holes (3) drilled to be mounted by bolts (6) with the 2 holes (3) at the base of the U-shape tab (4) made of steel plate welded on top of the Mounting-Plates (1), that was made of steel plate cut into round shape with the circular hole at the center to allow the exposure of the tip of the strut-shaft. The U-shape tap (4) that was welded on top of the Mounted-Plate (1) will have both wings to extend through the rim of the Mounting Plate (1) to round the tip of the shock-absorber shaft in the middle of the wing, at the rim of the Mounting-Plate (1) the holes (5) were drilled at the point that matched to be mounted to the existing bolt at the cap on the top of the Strut-Assembly.
